(19) United States
(12) Patent Application Publication
(10) Pub. No.: US 2026/0085733 A1
(43) Pub. Date: Mar. 26, 2026

(54) BRAKE ASSEMBLY OUTBOARD TIE BAR CLIP

(71) Applicant: HL MANDO CORPORATION, Gyeonggi-do (KR)

(72) Inventor: Kashif ARFEEN, Novi, MI (US)

(21) Appl. No.: 19/326,966

(22) Filed: Sep. 12, 2025

Related U.S. Application Data
(60) Provisional application No. 63/697,048, filed on Sep. 20, 2024.

(51) Int. Cl. F16D 65/097; F16D 55/226; F16D 127/02

(52) U.S. Cl. CPC F16D 65/0979; F16D 55/226; F16D 2127/02

(57) ABSTRACT

A brake assembly is provided. The brake assembly includes: a brake rotor configured to be rotatable with a wheel of a vehicle; a brake pad assembly configured to be engageable with the brake rotor; and a tie bar clip. The tie bar clip includes: an attachment portion attached to the brake pad assembly; at least one flexible leg extending from the attachment portion; and at least one anchor portion extending from the at least one flexible leg and configured to anchor the tie bar clip against a surface of a brake caliper of the brake assembly.

### CROSS REFERENCE TO PARENT APPLICATIONS

This application claims the benefit of U.S. patent application Ser. No. 63/697,048 filed on Sep. 20, 2024, entitled “Outboard Brake Pad Tie Bar Clips”, the entirety of which is incorporated herein by reference.

### BACKGROUND

Various embodiments of the present disclosure generally relate to a brake assembly and more particularly to an outboard tie bar clip for a brake assembly.

A brake system/assembly for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire. ”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Electric brake systems may also include an electric motor that controls movement of the electric actuator and sensors for measuring a position of the electric motor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake assembly may comprise: a brake rotor configured to be rotatable with a wheel of a vehicle; a brake pad assembly configured to be engageable with the brake rotor; and a tie bar clip. The tie bar clip may comprise: an attachment portion attached to the brake pad assembly; at least one flexible leg extending from the attachment portion; and at least one anchor portion extending from the at least one flexible leg and configured to anchor the tie bar clip against a surface of a brake caliper of the brake assembly.

The tie bar clip is attached to an outboard brake pad of the brake pad assembly and configured to apply a force in a direction of pulling the outboard brake pad away from the brake rotor.

The tie bar clip has a flexible material.

The tie bar clip is configured to, as the outboard brake pad is moved toward the brake rotor, be pulled by the outboard brake pad such that the at least one flexible leg is deformed into a deformed state.

The at least one flexible leg of the tie bar clip is configured to, when no force for moving the outboard brake pad toward the brake rotor is applied, return to an original state from the deformed state.

The tie bar clip is configured to, when the at least one flexible leg of the tie bar clip returns to the original state from the deformed state, exert a pulling force on the outboard brake pad of the brake pad assembly to pull the outboard brake pad away from the brake rotor.

The at least one anchor portion is configured to anchor the tie bar clip against the surface of the brake caliper using a point contact configuration.

The at least one anchor portion is configured to anchor the tie bar clip against a surface of a housing of the brake caliper.

The tie bar clip comprises at least two of each of the flexible legs and the anchor portions, and the at least two flexible legs extend in opposite directions from the attachment portion.

The at least two anchor portions are each configured to anchor the tie bar clip against a surface of a housing of the brake caliper.

According to various embodiments of the present disclosure, a tie bar clip for a brake assembly may comprise: an attachment portion configured to be attached to a brake pad assembly configured to be engageable with a brake rotor of the brake assembly; at least one flexible leg extending from the attachment portion; and at least one anchor portion extending from the at least one flexible leg and configured to anchor the tie bar clip against a surface of a brake caliper of the brake assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2A shows a cross-sectional view of the brake assembly of FIG. 1 with an outboard tie bar clip according to one or more exemplary embodiments of the present disclosure.

FIG. 2B shows a side view of the brake assembly of FIG. 1 with the outboard tie bar clip according to one or more exemplary embodiments of the present disclosure.

FIG. 2C shows a front view of the brake assembly of FIG. 1 with the outboard tie bar clip having a first attachment method to the brake assembly according to one or more exemplary embodiments of the present disclosure.

FIG. 2D shows a front view of the brake assembly of FIG. 1 with the outboard tie bar clip having a second attachment method to the brake assembly according to one or more exemplary embodiments of the present disclosure.

FIGS. 3A and 3B shows another example of the outboard tie bar clip according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

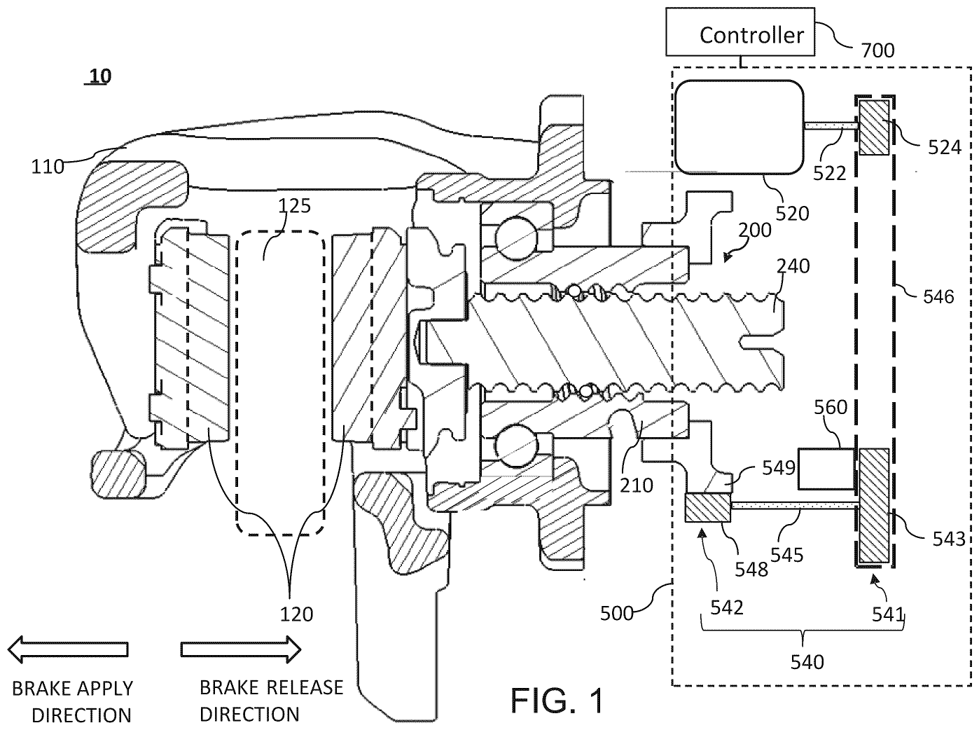

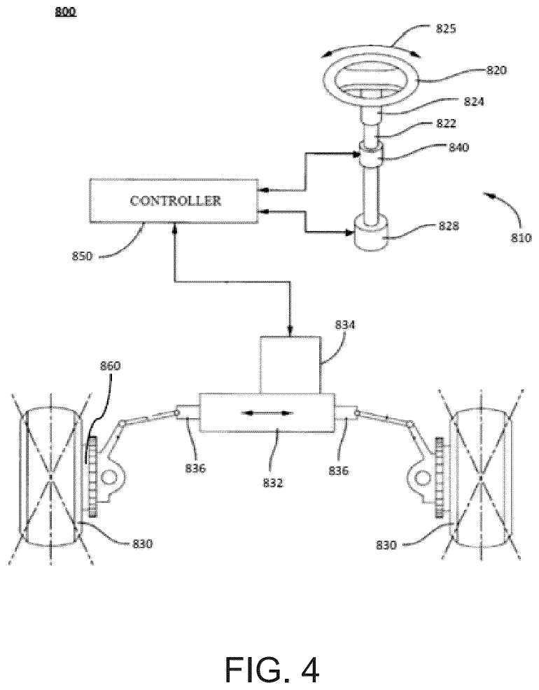

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems are usually susceptible to drag between the brake pads (e.g., brake pads of brake pad assembly 120 of FIG. 1) and the brake rotor (e.g., 125 of FIG. 1). Such drag not only causes increased, faster wear on the brake pads and brake rotor but also causes less efficient battery life for the vehicle's battery. More specifically, dragging brake calipers (e.g., where contact between the brake pads and the brake rotor still exist when braking operations are not required during regular driving operations) contributes to the reduced efficiency of vehicle battery life where approximately 0.5 mile loss per 1 Nm of drag from the brake caliper is experienced. Thus, unconventional solutions (e.g., the tie bar clip of embodiments disclosed herein) for reducing the possibility of dragging brake calipers are constantly being sought out.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake 560 is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

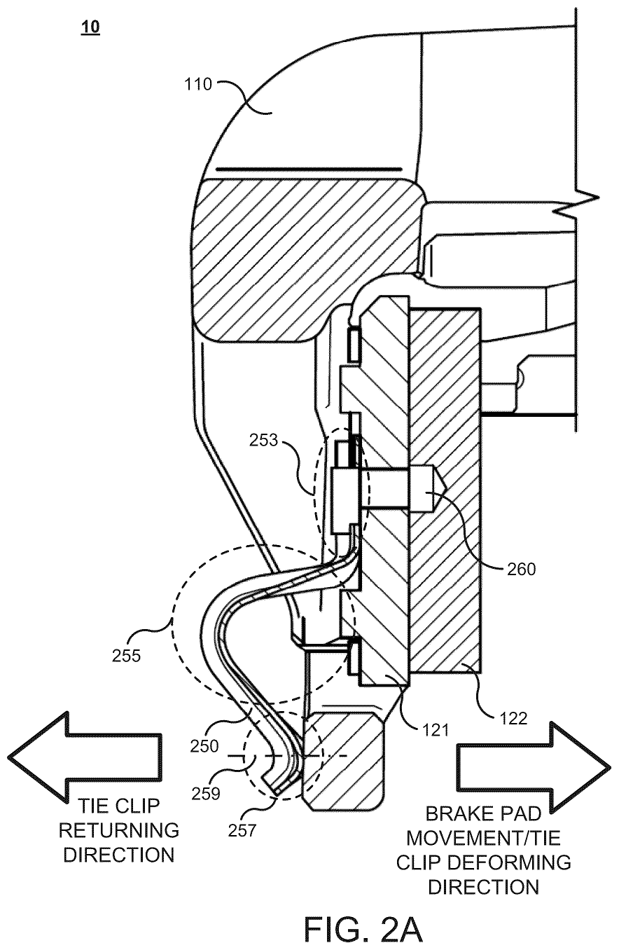

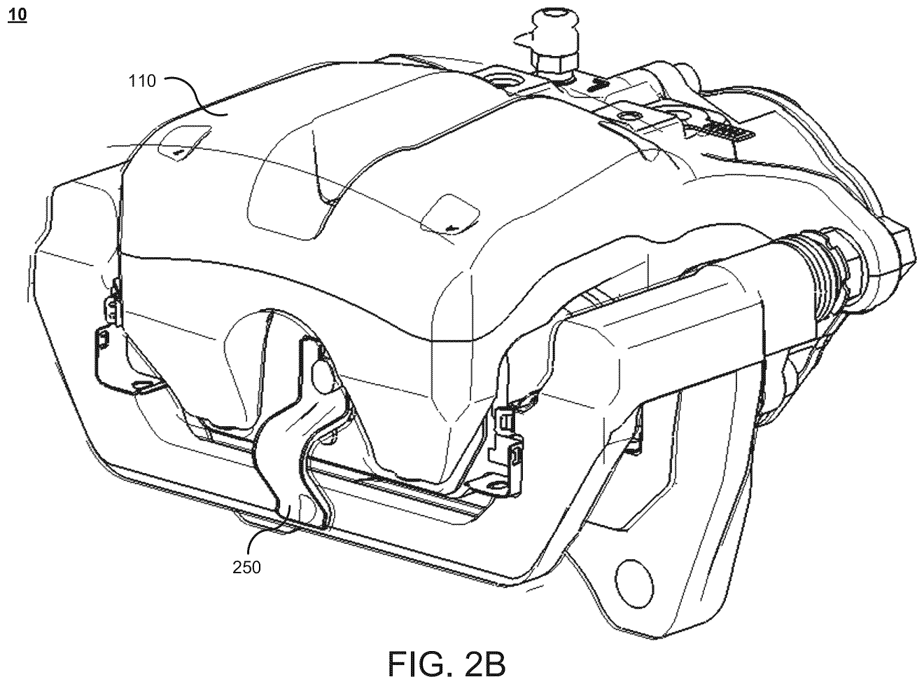

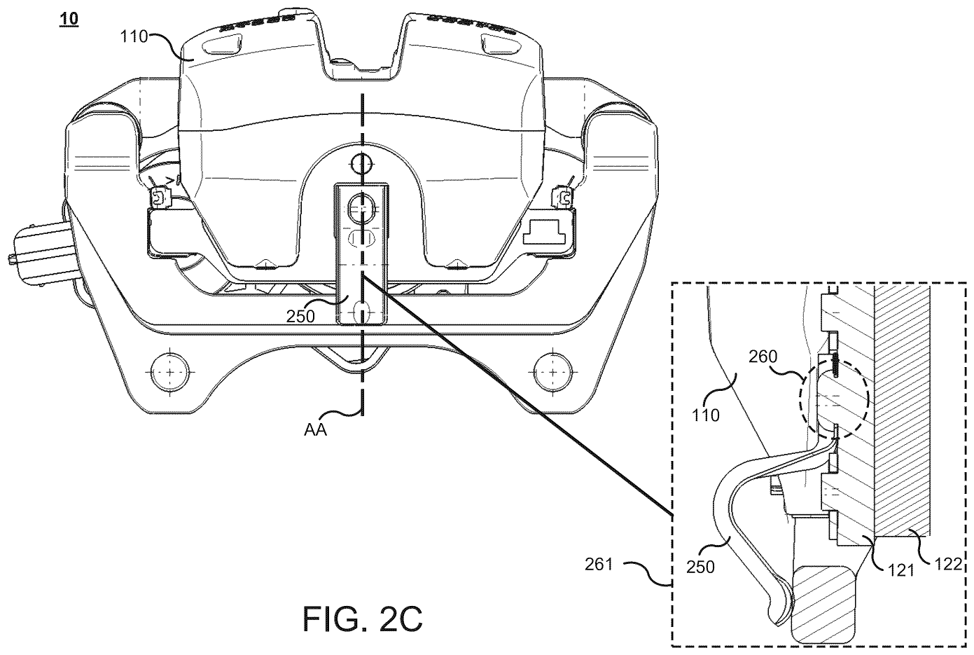

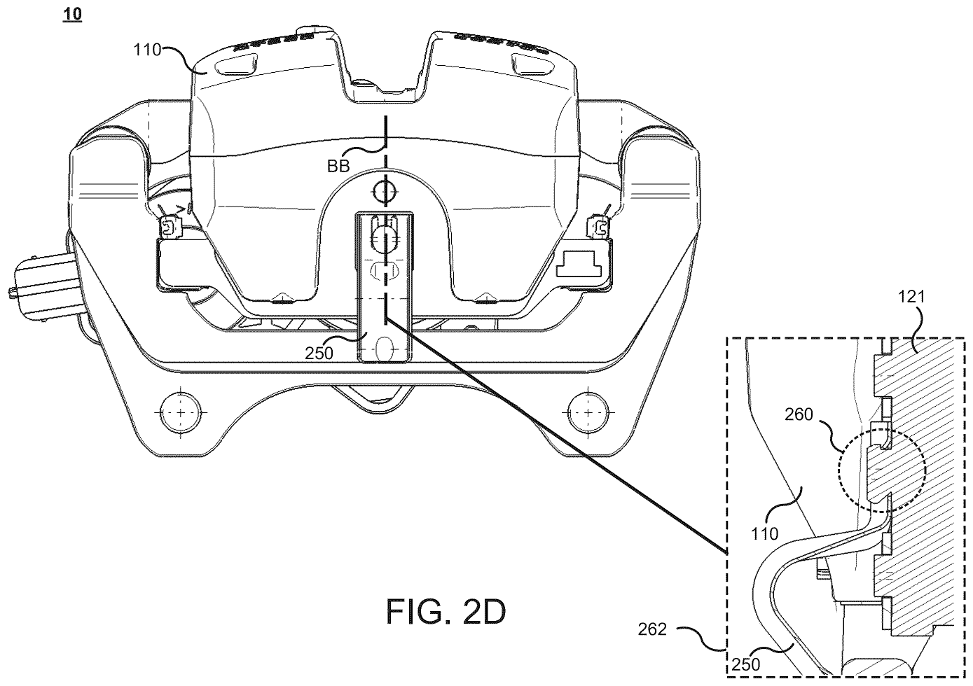

FIG. 2A shows a cross-sectional view of the brake assembly of FIG. 1 with an outboard tie bar clip 250 according to one or more exemplary embodiments of the present disclosure.

As shown in FIG. 2A, the outboard tie bar clip 250 is attached to an outboard brake pad 122 of the brake pad assembly 120. The outboard brake pad 122 may be the brake pad (e.g., of the brake pad assembly 120 shown in FIG. 1) that is not in direct contact with and that is not directly actuated by translatable part 240.

Furthermore, the outboard brake pad 122 may move in the brake release direction shown in FIG. 1 while the inboard brake pad (e.g., the other brake pad of the brake pad assembly 120 as shown in FIG. 1 that is in direct contact with and that is directly actuated by translatable part 240) moves towards the brake apply direction. Together the outboard brake pad 122 and the inboard brake pad move in respective directions to clamp onto and stop the rotation of the brake rotor 125 (e.g., during a braking operation of the vehicle on which the brake assembly 10 is installed).

In embodiments, the outboard brake pad 122 may be held by an outboard pad holder 121 of the brake pad assembly. Alternatively, these two components (e.g., the outboard brake pad 122 and outboard pad holder 121) may be formed as a single component (e.g., as a single output brake pad). The outboard pad holder 121 may be formed out of the same or a different material (e.g., metallic, semi-metallic, organic, ceramic, and/or polymeric material) as the outboard brake pad 122.

As further shown in FIG. 2A, the outboard tie bar clip 250 may be attached to the outboard brake pad 122 of via attachment means 260. Attachment means 260 may include, but is not limited to: a rivet, a screw, a plug, or any other component that is capable of securely attaching the outboard tie bar clip 250 to outboard brake pad 122. The attachment means 260 may also include components that can be used to attach the outboard tie bar clip 250 to the outboard brake pad 122 in a snap-on (or other similar retention) manner. Additional details regarding attachment of the outboard tie bar clip 250 to the outboard brake pad 122 are discussed in reference to FIG. 2A.

In embodiments, as also shown in FIG. 2B showing a side view of the brake assembly of FIG. 1 with the outboard tie bar clip according to one or more exemplary embodiments of the present disclosure, the outboard tie bar clip 250 may include at least an attachment portion 253, a flexible leg 255, and an anchor portion 257, all of which may be formed as a monolithic structure (i.e., the outboard tie bar clip 250 is formed in a single piece as a monolithic structure).

The attachment portion 253 may be formed at one end of the outboard tie bar clip 250 as a flat piece and is configured to engage with attachment means 260 to securely attach the outboard tie bar clip 250 to the outboard pad holder 121. In embodiments, the shape, size, and thickness of the attachment portion 253 may vary based on any combination of factors including, but not limited to: the size of the brake assembly 10, the size of the outboard pad holder 121/outboard brake pad 122, the size of the attachment means 260, or the like.

The flexible leg 255 may extend from attachment portion 253 and connect attachment portion 253 to the anchor portion 257 of the outboard tie bar clip 250. The flexible leg 255 may be formed in a curved fashion that allows the flexible leg 255 to be deformed as the outboard brake pad 122 is push toward the brake rotor 125 in the brake pad movement direction shown in FIG. 2A. In embodiments, the flexible leg 255 may be formed in any shape as long as the shape of the flexible leg 255 allows the flexible leg 255 to assert a pulling force on the outboard brake pad 122 (e.g., in the clip returning direction shown in FIG. 2A) to pull the outboard brake pad 122 back to its original position once a braking operation of the vehicle has ended.

The anchor portion 257 may be formed at an opposite end of the outboard tie bar clip 250 (i.e., an end opposite to the end forming the attachment portion 253) and is configured to anchor the outboard tie bar clip 250 against a body of the brake assembly 10 (e.g., a housing of the brake caliper 110 or the like). The anchor portion 257 may be configured with a shape that would allow the anchor portion 257 to have a point contact 259 with the body of the brake assembly.

In embodiments, the anchor portion 257 may be configured to not only limit the deformation of the outboard tie bar clip 250 (namely, the deformation of flexible leg 255) but also provide stability for the outboard tie bar clip 250 as the flexible leg 255 returns into its original shape when the electric motor 520 stops actuating the brake pad assembly 120.

Additionally, the outboard tie bar clip 250 may be formed using a flexible material (e.g., flexible metallic material such as stainless steel, flexible polymeric materials, or the like). Similar to the attachment portion 253, the shape, size, and thickness of the flexible leg 255 and the flexible leg 255 may respectively vary based on any combination of factors including, but not limited to: the size of the brake assembly 10, the size of the outboard pad holder 121/outboard brake pad 122, the size of the attachment means 260, or the like.

In embodiments, the attachment portion 253, the flexible leg 255, and the anchor portion 257 may be formed to have a uniform thickness. For example, the thickness of each portion of the outboard tie bar clip 250 may be any thickness between a thickness range of 0.4 mm to 2.00 mm, depending on a caliper force requirement of the outboard tie bar clip 250. Alternatively, certain portion of the outboard tie bar clip 250 (e.g., any of the attachment portion 253, the flexible leg 255, and the anchor portion 257) may be formed to be thicker than the other portions of the outboard tie bar clip 250. For example, the flexible leg 255 may be formed thicker than the other portions to be able to withstand the pulling force exerted on the outboard tie bar clip 250 when the outboard brake pad 122 moves in the brake pad movement direction shown in FIG. 2A such that the flexible leg 255 does not get completely deformed (e.g., bent, or the like) to a point where the flexible leg 255 is unable to return to its original shape and position.

As further shown in FIGS. 2A and 2B, the outboard tie bar clip 250 is configured to be attached to the brake assembly 10 at a bottom part of the brake assembly 10 where the outboard brake pad 122 of the brake pad assembly 120 is exposed to an external environment of the brake assembly. Additionally, for stability, the outboard tie bar clip 250 is configured to be attached to the outboard brake pad 122 (e.g., via attachment portion 253) and to the brake assembly 10 (e.g., via anchor portion 257) in a straight manner.

Even further, the outboard tie bar clip 250 may be configured to be attached to a center (e.g., a center point) of the outboard pad holder 121/outboard brake pad 122. This advantageously allows the outboard tie bar clip 250 to pull the outboard brake pad 122 away from the brake rotor 125 (namely, to eliminate drag) but also to center the outboard brake pad 122 as the outboard brake pad 122 is pulled back to its original, pre-braking position. As a result, more uniform braking may be applied by the outboard brake pad 122 after the outboard brake pad 122 is centered since no one portion of the outboard brake pad 122 will contact the brake rotor 125 first before other portions of the outboard brake pad 122 when a braking operation of the vehicle is initiated.

Turning now to FIG. 2C, FIG. 2C shows an example of embodiments disclosed herein where the outboard tie bar clip 250 is attached (e.g., directly or indirectly) to the outboard brake pad 122 using a riveting attachment method. More specifically, the attachment portion 253 of the outboard tie bar clip 250 is riveted to the brake pad assembly 120 (namely, the outboard pad holder 121 and/or the outboard brake pad 122 of the brake pad assembly 120). In this example, the attachment means 260 (as shown in the enlarged view 261 of cross section AA of the brake assembly 10) may be a rivet.

FIG. 2D shows another an example of embodiments disclosed herein where the outboard tie bar clip 250 is attached (e.g., directly or indirectly) to the outboard brake pad 122 using a snap-on attachment configuration. More specifically (and as shown in the enlarged view 262 of cross section BB of the brake assembly 10), attachment means 260 may be formed directly on the brake pad assembly 120 as a protrusion on the outboard pad holder 121 and/or the outboard brake pad 122 of the brake pad assembly 120. The shape and size of the protrusion is configured to be form fitting with an opening (e.g., a hole of the like) formed on attachment portion 253 of the outboard tie bar clip 250 such that the attachment portion 253 of the outboard tie bar clip 250 is able to be clipped on to the outboard pad holder 121 and/or the outboard brake pad via the protrusion. Alternatively, the attachment means 260 may also be a separate component that is attached (e.g., nailed in, screwed in, inserted into, riveted onto, or the like) the outboard pad holder 121 and/or the outboard brake pad, and the separate component comprises a portion with a shape that is configured for the attachment portion 253 of the outboard tie bar clip 250 too clip onto to secure the attachment portion 253 of the outboard tie bar clip 250 to the brake pad assembly 120 via the attachment means 260.

Although the outboard tie bar clip 250 is shown to have a specific shape and attachment configuration in FIG. 2A through FIG. 2D, a person having ordinary art will appreciate that the outboard tie bar clip 250 may have any shape and may be attached to the brake assembly 10 in any configuration, without departing from the scope of embodiments disclosed herein, as long as the outboard tie bar clip 250 is able to pull the outboard brake pad 122 of the brake pad assembly 120 back to its original position after a braking operation as ended (e.g., after a force causing the outboard brake pad 122 to clamp against the brake rotor 125 has been stopped).

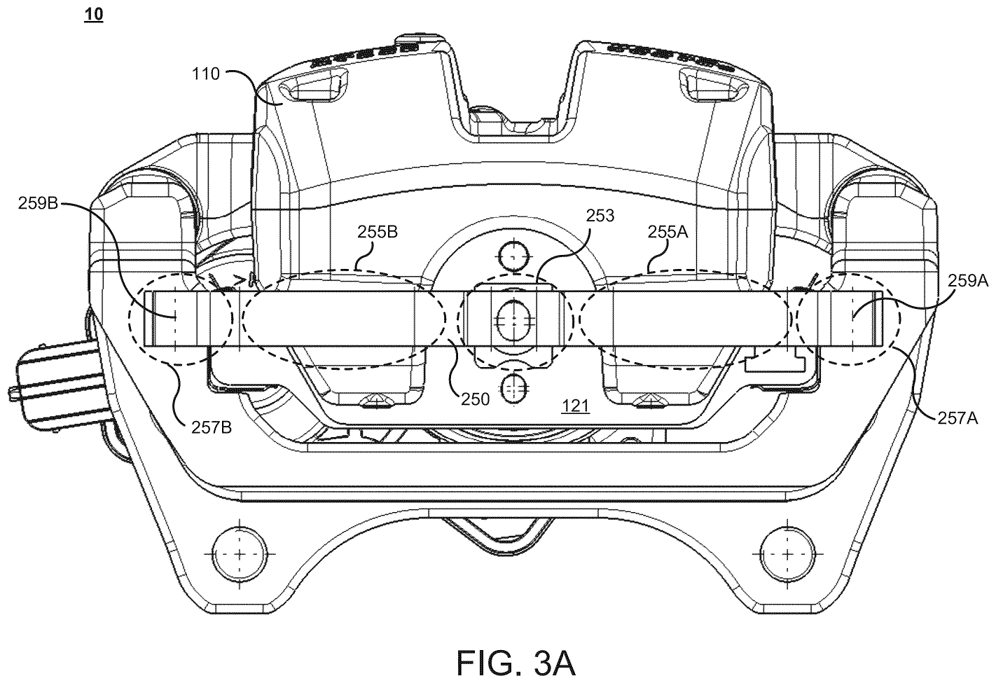

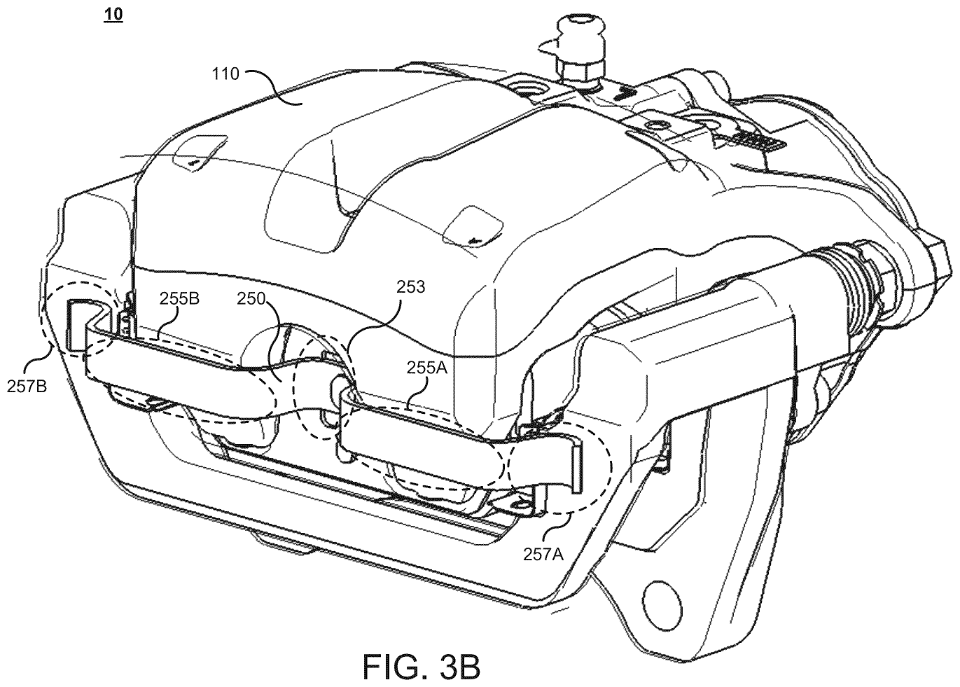

FIGS. 3A and 3B shows another example of the outboard tie bar clip 250 according to one or more exemplary embodiments of the present disclosure.

The example outboard tie bar clip 250 of FIGS. 3A and 3B is configured to include two each of the flexible leg 255 and the anchor portion 257 shown in FIGS. 2A-2D. In particular, a first flexible leg 255A in configured to extend outward from the attachment portion 253 in a first direction while a second flexible leg 255B is configured to extend outward from the attachment portion in a second direction directly opposite to the first direction. Said another way, the two flexible legs 255A and 255B are like wings that extend out in opposite directions from attachment portion 253.

As shown in FIGS. 3A and 3B, the first flexible leg 255A connects the attachment portion 253 to a first anchor portion 257A that is configured to be in point contact at position 259A with the brake assembly 10 (e.g., a housing of brake assembly 10). Similarly, the second flexible leg 255B connects the attachment portion 253 to a second anchor portion 257B that is configured to be in point contact at position 259B with the brake assembly 10 (e.g., a housing of brake assembly 10).

In this example of the outboard tie bar clip 250 of FIGS. 3A and 3B, both of the first flexible leg 255A and the second flexible leg 255B are deformed as a braking operation is being performed by the brake assembly 10. Once the braking operation ends, both of the first flexible leg 255A and the second flexible leg 255B (using their flexible nature) return to their original shape and position while pulling the outboard brake pad 122 back (e.g., away from the brake rotor 125) during this process.

As shown in FIGS. 3A and 3B, the outboard tie bar clip 250 is attached horizontally against the brake assembly 10 (e.g., a housing of the brake assembly 10). However, embodiments disclosed herein is not limited to this configuration and the outboard tie bar clip 250 can be attached to the brake assembly 10 in any configuration (e.g., horizontally, vertically, slanted at an angle, or the like) depending on at least one or more factors such as, but not limited to: shape of the brake assembly 10, a position of the outboard brake pad 122 within the brake assembly 10, a size of the brake assembly 10, where on the brake assembly 10 the outboard tie bar clip 250 can be most securely attached, the shape and size of the outboard tie bar clip 250, or the like.

With both examples of the of the outboard tie bar clip 250 shown in FIGS. 2A-3B, the outboard brake pad 122 can be advantageously pulled away from the brake rotor 125 at the end of a braking operation such that drag between the outboard brake pad 122 and the brake rotor 125 can (advantageously) be completely eliminated.

Although the above figures have been described with respect to an EMB, any type of brake assemblies (e.g., EMBs, hydraulic brakes, steer-by-wire, etc.) may be applicable and adapted to be used with the guide pin boot of embodiments disclosed herein. For example, all instances of the term “EMB” used throughout this disclosure can be replaced with any other type of brake assemblies (e.g., hydraulic brakes, steer-by-wire, traditional, etc.).

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake assembly comprising:
a brake rotor configured to be rotatable with a wheel of a vehicle;
a brake pad assembly configured to be engageable with the brake rotor; and
a tie bar clip comprising:
an attachment portion attached to the brake pad assembly;
at least one flexible leg extending from the attachment portion; and
at least one anchor portion extending from the at least one flexible leg and configured to anchor the tie bar clip against a surface of a brake caliper of the brake assembly.

2. The brake assembly of claim 1, wherein the tie bar clip is attached to an outboard brake pad of the brake pad assembly and configured to apply a force in a direction of pulling the outboard brake pad away from the brake rotor.

3. The brake assembly of claim 2, wherein the tie bar clip has a flexible material.

4. The brake assembly of claim 2, wherein the tie bar clip is configured to, as the outboard brake pad is moved toward the brake rotor, be pulled by the outboard brake pad such that the at least one flexible leg is deformed into a deformed state.

5. The brake assembly of claim 4, wherein the at least one flexible leg of the tie bar clip is configured to, when no force for moving the outboard brake pad toward the brake rotor is applied, return to an original state from the deformed state.

6. The brake assembly system of claim 5, wherein the tie bar clip is configured to, when the at least one flexible leg of the tie bar clip returns to the original state from the deformed state, exert a pulling force on the outboard brake pad of the brake pad assembly to pull the outboard brake pad away from the brake rotor.

7. The brake assembly of claim 1, wherein the at least one anchor portion is configured to anchor the tie bar clip against the surface of the brake caliper using a point contact configuration.

8. The brake assembly of claim 1, wherein the at least one anchor portion is configured to anchor the tie bar clip against a surface of a housing of the brake caliper.

9. The brake assembly of claim 1, wherein the tie bar clip comprises at least two of each of the flexible legs and the anchor portions, and the at least two flexible legs extend in opposite directions from the attachment portion.

10. The brake assembly of claim 9, wherein the at least two anchor portions are each configured to anchor the tie bar clip against a surface of a housing of the brake caliper.

11. A tie bar clip for a brake assembly comprising:
an attachment portion configured to be attached to a brake pad assembly configured to be engageable with a brake rotor of the brake assembly;
at least one flexible leg extending from the attachment portion; and
at least one anchor portion extending from the at least one flexible leg and configured to anchor the tie bar clip against a surface of a brake caliper of the brake assembly.

12. The tie bar clip of claim 11, wherein the tie bar clip is attached to an outboard brake pad of the brake pad assembly and apply a force in a direction of pulling the outboard brake pad away from the brake rotor.

13. The tie bar clip of claim 12, wherein the tie bar clip has a flexible material.

14. The tie bar clip of claim 13, wherein the time bar clip is configured to, as the outboard brake pad is moved toward the brake rotor, be pulled by the outboard brake pad such that the at least one flexible leg is deformed into a deformed state.

15. The tie bar clip of claim 14, wherein the at least one flexible leg of the tie bar clip is configured to, when no force for moving the outboard brake pad toward the brake rotor is applied, return to an original state from the deformed state.

16. The tie bar clip of claim 15, wherein the tie bar clip is configured to, when the at least one flexible leg of the tie bar clip returns to the original state from the deformed state, exert a pulling force on the outboard brake pad of the brake pad assembly to pull the outboard brake pad away from the brake rotor.

17. The tie bar clip of claim 12, wherein the at least one anchor portion is configured to anchor the tie bar clip against the surface of the brake caliper using a point contact configuration.

18. The tie bar clip of claim 11, wherein the at least one anchor portion is configured to anchor the tie bar clip against a surface of a housing of the brake caliper.

19. The tie bar clip of claim 11, wherein the tie bar clip comprises at least two of each of the flexible legs and the anchor portions, and the at least two flexible legs extend in opposite directions from the attachment portion.

20. The tie bar clip of claim 19, wherein the at least two anchor portions are each configured to anchor the tie bar clip against a surface of a housing of the brake caliper.
